(19) United States
(12) Patent Application Publication
(10) Pub. No.: US 2026/0249245 A1
(43) Pub. Date: Aug. 27, 2026

(54) Carbon Dioxide Valorization Through Cation-Gradient Carbon Dioxide Capture and Electrolysis Coupled to Electrochemical Electrolyte Decarbonation

(71) Applicant: Dioxycle, Saint Ouen sur Seine (FR)

(72) Inventors: David Wakerley, Paris (FR); Joshua A. Rabinowitz, San Francisco, CA (US)

(21) Appl. No.: 19/533,707

(22) Filed: Feb. 9, 2026

Related U.S. Application Data
(60) Provisional application No. 63/763,892, filed on Feb. 26, 2025.

(51) Int. Cl. B01D 53/96; B01D 53/62; B01D 53/78; C25B 1/04; C25B 1/16; C25B 1/23; C25B 3/03; C25B 3/26; C25B 5/00; C25B 9/23; C25B 9/70; C25B 13/02; C25B 15/08

(52) U.S. Cl. CPC B01D 53/965; B01D 53/62; B01D 53/78; C25B 1/04; C25B 1/16; C25B 1/23; C25B 3/03; C25B 3/26; C25B 5/00; C25B 9/23; C25B 9/70; C25B 13/02; C25B 15/087; B01D 2251/30; B01D 2251/604; B01D 2251/606; B01D 2257/504; B01D 2258/0283; B01D 2258/05; B01D 2258/06

(57) ABSTRACT

This disclosure relates to systems and methods for capturing and valorizing carbon dioxide into useful chemicals. A disclosed system includes a carbon dioxide capture block, a decarbonation electrolyzer to generate a concentrated carbon dioxide stream, and a carbon dioxide electrolyzer that converts the carbon dioxide to reduced carbon products. The system also regenerates and recycles carbon dioxide capturing materials into a closed loop.

### CROSS REFERENCE TO RELATED APPLICATIONS

This application claims the benefit of U.S. Provisional Pat. App. No. 63/763,892, filed Feb. 26, 2025, which is incorporated by reference herein in its entirety for all purposes.

### BACKGROUND

In order to combat global warming, there is an urgent need to displace virgin-fossil-resource-based fuels and chemicals with low-carbon-intensity fuels and chemicals. Producing chemicals from hydrocarbons without releasing carbon dioxide (CO₂) emissions through strategies such as electrification of heat production to replace traditional gas-fired heaters is an area of technology being investigated. Producing chemicals and fuels from the recycling of carbon dioxide is another area of technology currently being investigated. This second strategy presents the dual environmental benefit of capturing carbon emissions from a first process into a chemical while also avoiding the emission of conventional fossil fuels usually employed to produce such chemicals.

Electrochemical technologies for both CO₂ capture and subsequent conversion to fuels and chemicals are technically feasible but require energy efficiency improvements to lower operational and capital costs enough to make the generated fuels and chemicals cost competitive with fossil sources. For example, an electrolyzer has been reported for the capture of CO₂ but requires greater than 2 volts to undertake this reaction at moderate current density. Other systems have attempted to undertake the conversion of bicarbonate/carbonate solutions, formed from capturing CO₂ gas, into valuable products, such as carbon monoxide (CO), by the simultaneous conversion of carbonate to CO₂ and its immediate electrochemical reduction. In an example of such a reactor, a potential greater than 3 volts was required to undertake the conversion and the non-optimized condition leads to unfavorable selectivity for CO₂ conversion, with Faradaic efficiency (FE) less than 50% being reported. The above limitations are related to the fact that the electrochemical generation of CO₂ from bicarbonate/carbonate and the subsequent electrochemical conversion of CO₂ to valuable products work most efficiently in distinctly different operating conditions. Attempts to combine this into one reactor leads to voltage penalties.

### SUMMARY

This disclosure relates to integrated electrochemical systems and methods for capturing CO₂ and converting the captured CO₂ into valuable reduced carbon products while regenerating alkaline capture media and other intermediate products in a closed loop. In disclosed systems, CO₂ contained in a gaseous stream is contacted with an alkaline media to form an alkali metal bicarbonate, which is subsequently electrochemically decarbonated to produce a concentrated CO₂ stream and an alkali metal hydroxide stream. The concentrated CO₂ stream is sent to a CO₂ reduction electrolyzer that converts CO₂ into one or more reduced carbon products. The CO₂ electrolyzer concurrently regenerates the alkaline capture media, for example an alkali metal carbonate, which is recycled to the CO₂ capture block, thereby enabling continuous CO₂ capture. The disclosed systems integrate carbon capture, CO₂ concentration, and electrochemical conversion into a single process architecture, reducing energy consumption, minimizing parasitic losses associated with external separation or solvent regeneration (e.g., amine absorbers), and enabling efficient utilization of low-concentration or impure CO₂ sources such as flue gas, biogenic gas, or air.

In specific embodiments, the decarbonation electrolyzer may be operated in a conventional electrolysis mode, a depolarized mode in which electrochemically-generated hydrogen, oxygen, or other products are reused at an opposing electrode to reduce cell voltage, or a membrane-driven mode in which acid and base equivalents are generated using a bipolar membrane. For example, hydrogen generated at a cathode may be supplied to an anode for oxidation, or oxygen generated at an anode may be supplied to a cathode for reduction, thereby reducing the electrical energy required to liberate CO₂ and regenerate alkali metal hydroxide. In specific embodiments, the CO₂ reduction electrolyzer may be configured to operate in alkaline conditions with cation-driven ion transport that promotes in situ formation of alkali metal carbonate during electrochemical reduction of carbon dioxide, while producing reduced carbon products including carbon monoxide, ethylene, ethanol, acetic acid, and combinations thereof. In specific embodiments, additional downstream electrochemical or thermochemical conversion stages may be employed to further upgrade intermediate products.

In specific embodiments of the invention, a system is provided. The system includes a carbon dioxide capture block configured to contact a gaseous stream comprising carbon dioxide with an aqueous alkali metal carbonate to convert carbon dioxide into an aqueous alkali metal bicarbonate, a decarbonation electrolyzer that receives the aqueous alkali metal bicarbonate and electrochemically generates a concentrated carbon dioxide stream and an alkali metal hydroxide stream, and a carbon dioxide reduction electrolyzer that receives the concentrated carbon dioxide stream and the alkali metal hydroxide stream, electrochemically reduces a portion of the concentrated carbon dioxide stream to at least one reduced carbon product stream, and generates an alkali metal carbonate stream from a second portion of the concentrated carbon dioxide stream. The system also includes a recycling conduit fluidly connecting the carbon dioxide reduction electrolyzer and the carbon dioxide capture block whereby the alkali metal carbonate stream is transported to the carbon dioxide capture block.

In specific embodiments of the invention, a method is provided. The method includes contacting a gaseous stream comprising carbon dioxide with an aqueous alkali metal carbonate to capture at least a portion of the carbon dioxide as an alkali metal bicarbonate, decarbonating the aqueous alkali metal bicarbonate in a first electrolyzer to generate a concentrated carbon dioxide stream and an alkali metal hydroxide stream, feeding the concentrated carbon dioxide stream and the alkali metal hydroxide stream to a second electrolyzer, and electrochemically reducing carbon dioxide in the second electrolyzer to produce at least one reduced carbon product. The method also includes transporting alkali metal cations within the second electrolyzer toward a cathode to promote in situ formation of alkali metal carbonate and recycling the alkali metal carbonate to the contacting step, where the reduced carbon product and the alkali metal carbonate are each generated using a portion of the concentrated carbon dioxide stream.

In specific embodiments of the invention, a system is provided. The system includes a carbon dioxide capture block configured to absorb carbon dioxide from a gaseous stream into an aqueous stream to form an aqueous alkali metal bicarbonate, a depolarized decarbonation electrolyzer that receives the aqueous alkali metal bicarbonate and electrochemically generates a concentrated carbon dioxide stream and an alkali metal hydroxide stream, where at least one electrochemically generated product is reused at an opposing electrode to reduce a cell voltage. The system also includes a carbon dioxide reduction electrolyzer that receives the concentrated carbon dioxide stream and the alkali metal hydroxide stream from the decarbonation electrolyzer, electrochemically reduces carbon dioxide to at least one reduced carbon product, and generates an alkali metal carbonate. The system further includes a recycling conduit fluidly connecting the carbon dioxide reduction electrolyzer and the carbon dioxide capture block.

### BRIEF DESCRIPTION OF THE DRAWINGS

The accompanying drawings illustrate various embodiments of systems, methods, and various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides a diagram of a CO₂ capture and valorization system in accordance with specific embodiments of the inventions disclosed herein.

FIG. 2 provides a diagram of a CO₂ capture and valorization system including an additional electrolyzer in accordance with specific embodiments of the inventions disclosed herein.

FIG. 3 provides a diagram of a decarbonation electrolyzer in accordance with specific embodiments of the inventions disclosed herein.

FIG. 4 provides a diagram of variants of a hydrogen-depolarized decarbonation electrolyzer in accordance with specific embodiments of the inventions disclosed herein.

FIG. 5 provides a diagram of an oxygen-depolarized decarbonation electrolyzer in accordance with specific embodiments of the inventions disclosed herein.

FIG. 6 provides a diagram of a decarbonation electrolyzer also run as a fuel cell in accordance with specific embodiments of the inventions disclosed herein.

FIG. 7 provides a diagram of variants of a CO₂ electrolyzer in accordance with specific embodiments of the inventions disclosed herein.

FIG. 8 provides a diagram of variants of a CO electrolyzer in accordance with specific embodiments of the inventions disclosed herein.

FIG. 9 provides a diagram of a process of operating a CO₂ capture and valorization system in accordance with specific embodiments of the inventions disclosed herein.

FIG. 10 provides a diagram of a CO₂ capture and valorization system producing CO in accordance with specific embodiments of the inventions disclosed herein.

FIG. 11 provides a diagram of a CO₂ capture and valorization system producing CO, ethylene, and ethanol in accordance with specific embodiments of the inventions disclosed herein.

FIG. 12 provides a diagram of a CO₂ capture and valorization system producing syngas which feeds into a methanol reactor in accordance with specific embodiments of the inventions disclosed herein.

FIG. 13 provides a diagram of a CO₂ capture and valorization system producing CO and chlorine in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for CO₂ capture and valorization are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

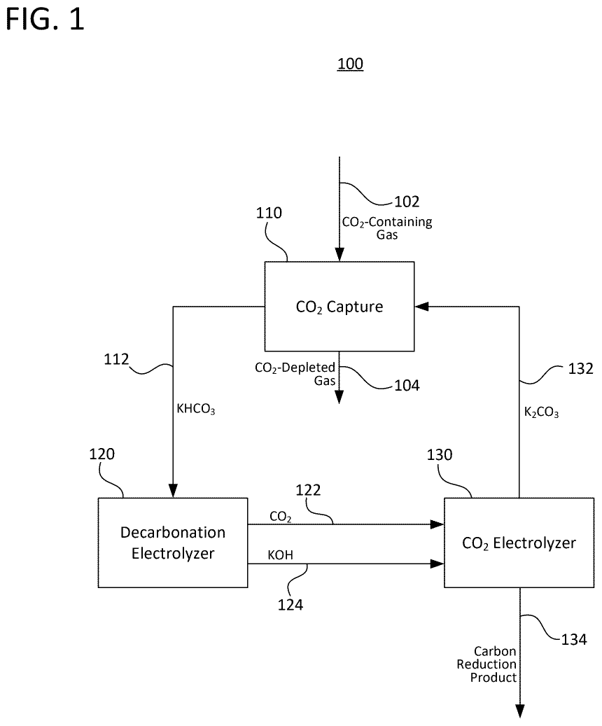

FIG. 1 shows a diagram of a carbon dioxide capture and valorization system 100 in accordance with specific embodiments of the inventions disclosed herein. The system includes a carbon dioxide capture block 110, a decarbonation electrolyzer 120, and a carbon dioxide electrolyzer 130 in a closed material loop that enables CO₂ capture, electrochemical concentration and conversion, and regeneration of alkaline capture media. In operation, a gaseous stream containing carbon dioxide is introduced into the system and ultimately converted into one or more reduced carbon products, while alkali metal cations and other intermediate species are continuously recycled such that the system can operate with little or no net consumption of alkaline reagents or alkali metals.

The carbon dioxide capture block 110 is configured to contact a gaseous stream 102 comprising carbon dioxide with an aqueous alkaline stream to chemically absorb carbon dioxide and form an aqueous alkali metal bicarbonate and/or carbonate solution. In specific embodiments, the aqueous alkaline stream comprises an alkali metal carbonate that reacts with carbon dioxide and water to form alkali metal bicarbonate according to Eq. 1, where M represents an alkali metal such as potassium (K).

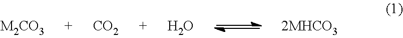

Conventional CO₂ capture systems can use highly alkaline solutions such as a metal hydroxide. While this can be effective, the alkalinity will often over-consume the input CO₂, which means an additional energy must be expended on the regeneration of the electrolyte. The capture block 110 as described herein can capture CO₂ from nearly any source, including, but not limited to the air, flue gas, biogenic streams, or unreacted CO₂ from other portions of the system 100. The CO₂ capture block 110 can capture carbon dioxide from dilute or concentrated gas sources. In this example, a CO₂-containing gas stream 102 is contacted with an alkaline capture media (e.g., alkaline metal carbonate stream 132) comprising a metal carbonate, in this case potassium carbonate. The capture media (e.g., alkaline metal carbonate stream 132) is produced in a downstream reactor (e.g., the electrolyzer 130) described hereinafter. A portion of CO₂ in the gas stream can be captured, leaving a CO₂-depleted gas stream 104. The CO₂ capture block 110 also discharges an aqueous potassium bicarbonate-containing liquid stream 112 from the capture block toward the downstream electrochemical processing stages. The CO₂ capture block 110 may include gas-liquid contactors, stirred vessels, packed columns, or other mass-transfer devices configured to promote efficient absorption of carbon dioxide into the aqueous alkaline medium. In specific embodiments, the capture block 110 can be configured to capture more than 50% of incoming CO₂ in the incoming CO₂-containing gas stream.

The bicarbonate-containing aqueous stream 112 from the capture block 110 is supplied to a decarbonation block, also referred to as a decarbonation electrolyzer 120, which electrochemically converts alkali metal bicarbonate into a concentrated carbon dioxide stream 122 and an alkali metal hydroxide stream 124, in this example potassium hydroxide. These two streams are fed into a CO₂ electrolyzer 130. The decarbonization electrolyzer 120 can output two separated streams as shown here, but in specific embodiments, the concentrated CO₂ and alkali metal hydroxide streams may exit the decarbonation electrolyzer together and be separated later. In various embodiments, the decarbonation electrolyzer 120 can be a standard one or two membrane electrolyzer, a depolarized electrolyzer, a bipolar membrane electrodialysis electrolyzer, or a fuel cell.

The decarbonation block has many possible configurations according to specific embodiments of the invention. It can have functional units similar to those used in electrodialysis or salt splitting technologies. The reactor contains a cathode and an anode, cathode electrolyte (catholyte) chambers, anode electrolyte (anolyte) chambers and at least one internal separator. During operation, a reduction reaction occurs at the cathode, which generates hydroxide ions. The hydroxide formed combines with an alkali metal ion, such as Li+, Na+, K+, Rb+, and Cs+. The alkali metal is either already present in solution or provided through a cation exchange membrane (CEM), forming an alkaline solution. Examples of such reactions are provided in Eqs. 2-5:

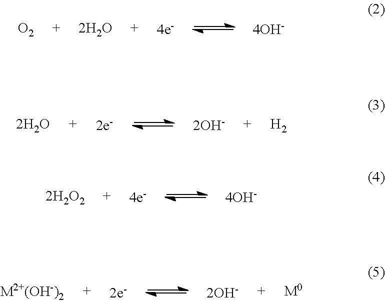

The cathode contains a catalyst comprised of one or more: molecular species, metal particles of any morphology, single-metal-site heterogeneous compounds, metal compounds, carbon-based compounds, polymer electrolytes (also referred to as ionomers), metal-organic frameworks, metal-doped covalent organic frameworks, or any other additives. The molecular species can be selected from metal porphyrins, metal phthalocyanines, or metal bipyridine complexes. The metal particles can be under the form of metal nanoparticles, nanowires, nano powder, nanoarrays, nanoflakes, nanocubes, dendrites, films, layers, or mesoporous structures. The catalyst may include one or a combination of the following: Cu, Ni, Ag, Au, Zn, Sn, Bi, Ni, Fe, Co, Pd, Ir, Pt, Mn, Ga, Ru, Rh, Pd, Re, Ru, La, Tb, Ce, Dy, or other lanthanides and alloys thereof. The carbon-based compounds can comprise carbon nanofibers, carbon nanotubes, carbon black, graphite, boron-doped diamond powder, diamond nanopowder, boron nitride, or a combination thereof. The additives can be halide-based compounds including F, Br, I, and Cl. The additives can be specifically dedicated to modifying hydrophobicity, such as treatment with polytetrafluoroethylene (PTFE) or carbon black. The cathode may further comprise a catalyst layer on a gas diffusion layer, a porous transport layer, or any other support, which encourages the diffusion of the gas from a stream to the surface of the catalyst, as well as allowing the release of non-reacted/product gases.

In parallel to the catalytic reductions at the cathode, an oxidation reaction occurs at the anode. The oxidation reaction is such that it is able to generate protons, or acid equivalents. The acidic equivalents that form interfaces with a stream containing alkali metal carbonate/bicarbonate metal ion, forming an acidic solution and CO₂ gas. Examples of such reactions are provided in Eqs. 6-9:

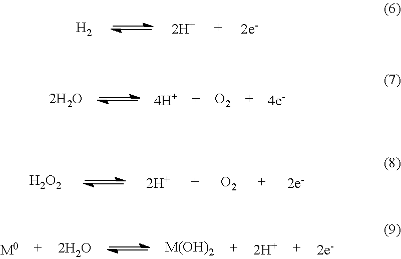

The anode contains a catalyst that can comprise one or more: molecular species, single metal-site heterogeneous compounds, metal particles of any morphology, carbon-based compounds, polymer electrolytes (also referred to as ionomers), metal-organic frameworks, metal doped covalent organic frameworks, or any other additives. The molecular species can be selected from metal porphyrins, metal phthalocyanines, or metal bipyridine complexes. The metal particles can be under the form of metal nanoparticles, nanowires, nano powder, nanoarrays, nanoflakes, nanocubes, dendrites, films, layers, or mesoporous structures. The single-metal-site compounds can comprise a metal-doped carbon-based material or a metal-N—C-based compound. Anodic catalyst species used for this purpose could include, but are not limited to, metals and/or ions of: Ir, Co, Cu, Ni, Fe, Pt, Rh, Re, Ru, Pd, Os, Mo, and mixtures and/or alloys thereof. For example, the anodic catalyst could be Pt such that the electrolyzer assembly included a platinum-based anode. The polymer electrolyte can be selected out of the same materials as the one used for the described membranes. The carbon-based compounds can comprise carbon nanofibers, carbon nanotubes, carbon black, graphite, boron-doped diamond powder, diamond nanopowder, boron nitride, or a combination thereof. The additives can be halide-based compounds including F, Br, I, and Cl. The additives can be specifically dedicated to modifying hydrophobicity such as treatment with PTFE or carbon black.

To separate the anodic and cathodic reactions, as well as the resulting products that form from them, separators are employed. The separator can be an ion-conducting polymeric separator, a non-ion conducting polymeric separator, a diaphragm, a ceramic-containing material, a noncharged separator scaffold, a mixed ceramic-organic compound separator, or any other separator. Separation may occur through the use of ion-exchange membranes, which favor the diffusion of either anions (in an anion-exchange membrane) or cations (in a cation-exchange membrane), or a bipolar membrane (including a mixture of cation- and anion-exchange membranes), or other types of separators, such as diaphragms, ceramic-containing materials (in particular mixed ceramic/organic compounds), or non-charged separator scaffolds. Anion-exchange membranes (AEMs) can comprise an organic polymer with positively charged functionality, such as, but not limited to, imidazolium, pyridinium, or tertiary amines. This allows facile migration of negatively charged anions, such as bicarbonate or carbonate, produced during the reduction reaction from the cathode to the anode. The use of this layer also prevents the crossover of other gases from the cathode to the separating layer. CEMs can comprise an organic polymer with negatively charged functionality such as, but not limited to, sulfonate groups. Diaphragms or non-charged separators can be materials derived from insulating materials which may be charged with an ion-conducting electrolyte to facilitate charge transfer between electrodes. Ceramic-containing materials may be a purely ceramic or mixed polymer and ceramic material, such as Zirfon. Ceramic-polymer mixes can reach higher temperatures than purely organic polymers and may take advantage of ion-exchange functionality in the polymer to pass charge between electrodes.

The concentrated carbon dioxide stream 122 is directed from the decarbonation electrolyzer 120 to a CO₂ electrolyzer 130, while the alkali metal hydroxide stream is also delivered to the CO₂ electrolyzer 130 for use as an alkaline electrolyte or reactant. In the carbon dioxide electrolyzer 130, a portion of the supplied carbon dioxide is electrochemically reduced at a cathode to generate at least one reduced carbon product stream 134, such as carbon monoxide or C₂+ products, while a second portion of the carbon dioxide reacts with electrochemically generated hydroxide to form an alkali metal carbonate stream 132. The alkali metal carbonate stream 132 is returned via a recycling conduit to the CO₂ capture block 110, thereby closing the alkaline capture loop. In specific embodiments, the carbon dioxide electrolyzer 130 employs a cation-driven ion transport configuration that transports alkali metal cations toward the cathode to promote in situ carbonate formation.

The CO₂ electrolyzer 130 can have a number of configurations according to specific embodiments of the invention. A carbon dioxide electrolyzer is a device comprising a cathode area where carbon dioxide reduction takes place, according to Eq. 10 below, and an anode area where an oxidation reaction takes place on an oxidizing catalyst. The oxidation substrate can be water, dihydrogen gas, halides, organic waste, or any other oxidation substrate. For example, the oxidation can involve water oxidation or dihydrogen oxidation according to Eqs. 11 and 12 below, respectively.

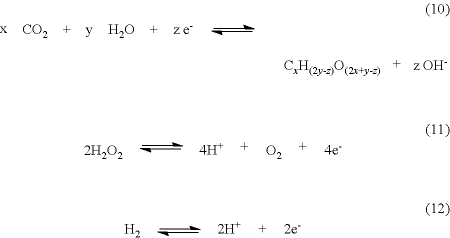

The reactions below can be conducted in accordance with the electrolyzer assemblies described herein. In the diagrams provided, only single cells are represented for clarity, but these could be assembled in a plurality of cells, such as in an electrolyzer stack. In the diagrams, a carbon dioxide electrolyzer comprises a cathode comprising a gas-diffusion layer and a cathode catalyst, and the anode comprises an anode catalyst deposited on a transport layer of any shape (such as, but not limited to, a foam, a mesh, a deposit onto a conductive porous transport layer (PTL), etc.). In the case where the carbon dioxide reduction product is carbon monoxide (CO), in neutral/alkaline conditions for CO₂ reduction:

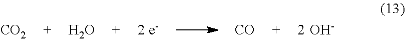

The electrode may also generate syngas, a mixture of H₂ and CO through a concomitant production of H₂ through Eq. 14.

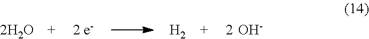

In tandem, the oxidation reaction at the anode is from the group consisting of reactions such as but not limited to equation 11, equation 12 or something similar to the following:

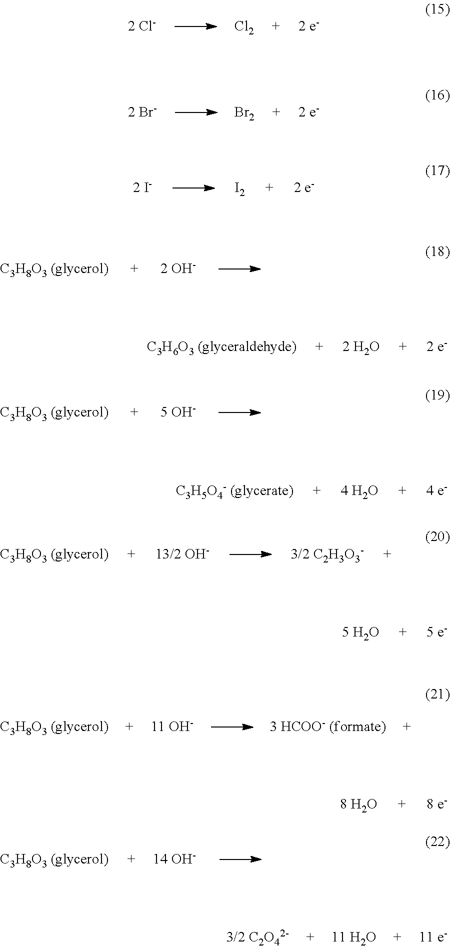

Unlike many other carbon dioxide gas electrolyzers, the carbon-capture and electrolysis unit is designed to transport alkali metal cations from the anode compartment to the cathode compartment where they may assist in carbon capture by forming alkali metal carbonates and bicarbonates. These cations may be Li⁺, Na⁺, K⁺, Rb⁺, Cs⁺, and Fr⁺. These cations reach the cathode catalyst layer via diffusion across a CEM or similar separator.

The CEM will electrodialyze M+ from the anode to the cathode where it reacts with generated hydroxide ions generated from reaction (10) to form MOH. In turn, this MOH will react with CO₂ interfacing the cathode stream, where it will form either bicarbonate or carbonate through equations 23 and 24, respectively:

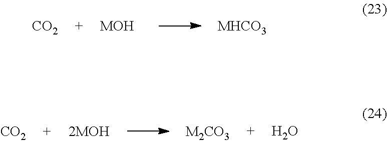

In some embodiments of the technology, the anodic electrolyte is an alkaline solution such as a solution of hydroxide-containing salt such as, but not limited to, potassium, sodium, or cesium hydroxide with concentrations such as (0.01 molarity (M), 0.05 M, 0.1 M, 0.2 M, 0.5 M, 1 M, 2 M, 3 M, 4 M, 5 M, 6 M, 7 M, 8 M, 9 M, and 10 M). The use of concentrated alkaline solution brings down the energy requirement of the overall reaction. Alkali metal cations (such as Li, Na, K, Cs, Rb) may be used as counter-cations. Given that the conductivity of the system is determined by the electrolyte, changes to electrolyte composition and concentration have considerable influence on the voltage/current characteristics and selectivity of the device.

To best control the formation of such aqueous species in the cathodic chamber, a controlled aqueous flow is maintained next to the cathode. This may be achieved using a hydrophilic layer with a separate outlet for liquid flow. This may be a percolator or solid electrolyte that is sufficiently porous to allow the flow of liquid out of the cathodic chamber without encroaching on the areas of the electrolyzer intended for the flow of carbon dioxide gas and the products of the reduction reaction. The liquid flowing through this percolator is called the catholyte and may contain supporting electrolyte ions to increase the conductivity of the catholyte, to improve the energetics of another step in the electrochemical system, to promote the dissolution of CO₂, or to increase the activity (d=ecrease the overpotential) of the CO₂-converting reaction. Examples of supporting electrolytes include, but are not limited to, alkali metal salts of Cl⁻, Br⁻, I⁻, F⁻, SO₄²⁻, CO₃²⁻, HCO₃⁻, ClO₄⁻. The catholyte flow will also be able to collect liquid products formed during electrolysis, including, but not limited to, formate, acetate, ethanol, and n-propanol.

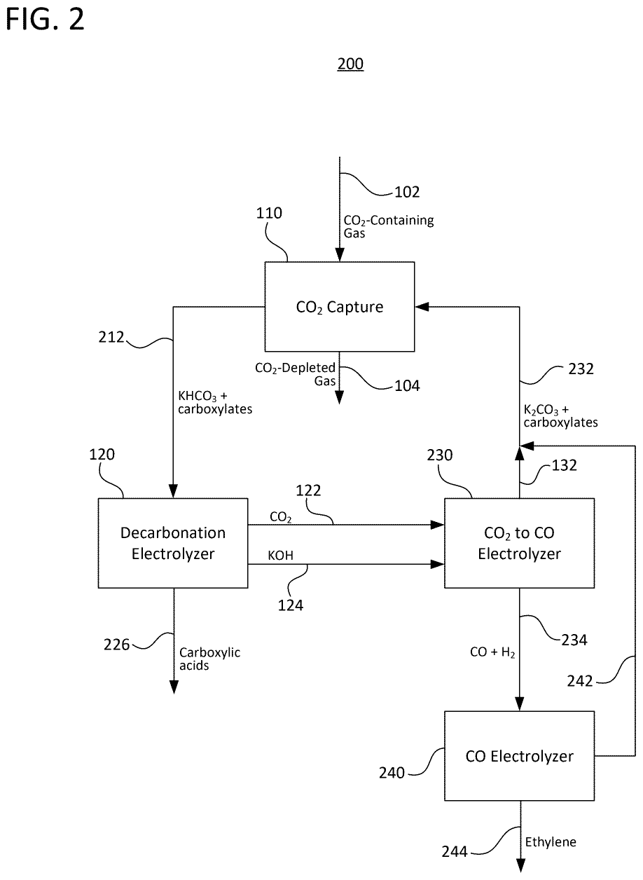

FIG. 2 shows a diagram of a carbon dioxide capture and valorization system 200 in accordance with specific embodiments of the inventions. System 200 is generally similar to the system 100 of FIG. 1, except that the system further includes an additional downstream electrolyzer configured to electrochemically convert a CO product stream into other C2+ products. The CO₂ electrolyzer 130 of system 100 has been configured in system 200 as electrolyzer 230 to produce a CO product stream 234 as an output. The system 200 includes a CO₂ capture block 110, a decarbonation electrolyzer 120, and a CO₂ to CO electrolyzer 230 arranged in a closed material loop as previously described. The system 200 additionally includes a CO electrolyzer 240 positioned downstream of the CO₂ electrolyzer 230. In this embodiment, the CO₂ electrolyzer 230 is operated to preferentially generate a reduced carbon product stream 234 comprising CO. The product stream 234 may also include some hydrogen gas which is co-generated by the hydrogen evolution reaction (HER), which can be a byproduct, but in some cases is a valuable side product. The CO-containing stream 234 is routed to the CO electrolyzer 240 for further electrochemical conversion to higher-value C2+ products, such as ethylene, ethanol, acetic acid, or combinations thereof, while the alkali metal carbonate stream 132 generated in the carbon dioxide electrolyzer 230 continues to be recycled to the carbon dioxide capture block 110 as described above.

In specific embodiments, the CO product stream 234 exiting the CO₂ electrolyzer 230 may optionally be purified or conditioned to remove residual CO₂ or moisture prior to being introduced into the CO electrolyzer 240. The CO electrolyzer 240 electrochemically reduces at least a portion of the carbon monoxide to one or more multi-carbon products. In this example, a gaseous output stream 244 comprises ethylene. In specific embodiments, the CO electrolyzer 240 can also produce liquid product streams depending on the selected operating conditions and catalyst configuration. Liquid outputs can contain alcohols or carboxylates. In specific embodiments, the liquid products such as carboxylates in stream 242 can be combined with stream 132 to create an input stream 232 comprising both potassium carbonate and carboxylates. The carboxylates will not generally affect the CO₂ capture in the capture block 110, but the carboxylates will pass through into stream 212 that includes both carboxylates as well as captured CO₂ in the form of a bicarbonate. In specific embodiments, carboxylates can be acidified in the decarbonation electrolyzer 120 to form a carboxylic acid stream 226. In the configuration as shown, the addition of the carbon monoxide electrolyzer 240 enables decoupling of the CO₂-to-CO conversion from the downstream CO-to-C2+ conversion, allowing each electrolyzer to be independently optimized for voltage efficiency, selectivity, current density, and product distribution. Aside from the inclusion of the CO electrolyzer 240 and the associated product streams 242 and 244, the material flows, recycle of alkali metal species, and operation of the carbon dioxide capture block 110, decarbonation electrolyzer 120, and carbon dioxide electrolyzer 230 remain substantially the same as described with respect to FIG. 1.

A CO electrolyzer 240 has many possible configurations according to specific embodiments of the invention. A carbon monoxide electrolyzer is a device comprising of a cathode area where CO reduction takes place, according to Eq. 25 below, and an anode area where an oxidation reaction takes place on an oxidizing catalyst. The oxidation substrate can be hydroxide, water, dihydrogen gas, halides, organic waste or any other oxidation substrate. For example, the oxidation can involve water oxidation or dihydrogen oxidation according to Eqs. 26 and 27 below respectively.

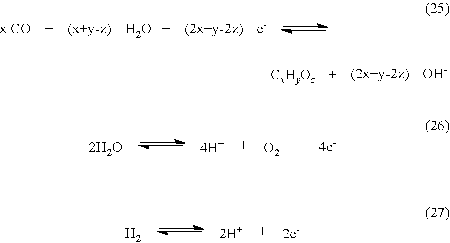

The reactions below can be conducted in accordance with the electrolyzer assemblies described herein. In the diagrams provided herein, only single cells are represented for clarity but these could be assembled in a plurality of cells, such as in an electrolyzer stack. In the diagrams, a carbon monoxide electrolyzer comprises a cathode comprising a gas-diffusion layer and a cathode catalyst, and the anode comprises an anode catalyst deposited on a transport layer of any shape (such as, but not limited to, a foam, a mesh, a deposit onto a conductive PTL, etc.). In this case, the carbon monoxide reduction products include one or more of the following: ethylene (C₂H₄), ethanol (C₂H₅OH), acetic acid (CH₃COOH), propylene (C₃H₆), propanol (C₃H₈O), propionic acid (C₂H₅COOH), oxalic acid (COOH—COOH), acrylic acid (C₂H₃COOH), and glyoxylic acid (COH—COOH). Examples of CO reduction reactions in neutral/alkaline conditions include:

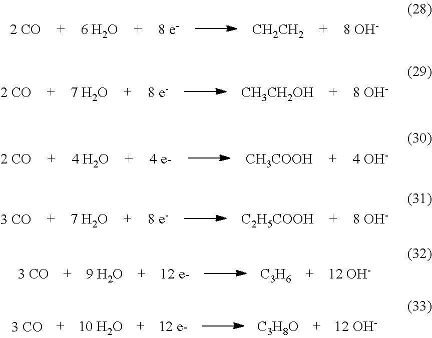

In specific embodiments of the invention, the cathode area could comprise a catalyst layer able to reduce carbon monoxide to generate value-added hydrocarbons/alcohols/organic acids or carboxylates. The catalyst can comprise one or more: molecular species, single-metal-site heterogeneous compounds, metal particles, carbon-based compounds, polymer electrolytes (also referred to as ionomers), metal-organic frameworks, metal-doped covalent organic frameworks, or any other additives. The molecular species can be selected from metal porphyrins, metal phthalocyanines, or metal bipyridine complexes. The metal particles can be under the form of metal nanoparticles, nanowires, nano powder, nanoarrays, nanoflakes, nanocubes, dendrites, films, layers, or mesoporous structures. Examples of metals include, but are not exclusively, one or more of Cu, Ni, Ag, Au, Zn, Sn, Bi, Fe, Co, Pd, Ir, Pt, Mn, Ga, Ru, Rh, Pd, Re, Ru, La, Tb, Ce, and Dy. The ionomers and or binders can be selected out of the same materials as the one used for the described membranes. The carbon-based compounds can comprise carbon nanofibers, carbon nanotubes, carbon black, graphite, boron-doped diamond powder, diamond nanopowder, boron nitride, or a combination thereof. The additives can be halide-based compounds including F, Br, I, and Cl. The additives can be specifically dedicated to modifying hydrophobicity such as treatment with PTFE or carbon black. The cathode may further comprise a catalyst layer on a gas diffusion layer, a porous transport layer, or any other support, which encourages the diffusion of the gas from a stream to the surface of the catalyst, as well as allowing the release of non-reacted/product gases. The cathode area could also include a gas diffusion layer with one or more separators such as, but not limited to, membranes, polymeric materials, diaphragms, and inorganic materials on its borders as described below.

In specific embodiments of the invention, the anode area could comprise an anodic catalyst layer able to oxidize a substance to produce a product and protons. The catalyst can comprise one or more: molecular species, single-metal-site heterogeneous compounds, metal particles, carbon-based compounds, polymer electrolytes (also referred to as ionomers), metal-organic frameworks, metal-doped covalent organic frameworks, or any other additives. The molecular species can be selected from metal porphyrins, metal phthalocyanines, or metal bipyridine complexes. The metal particles can be under the form of metal nanoparticles, nanowires, nano powder, nanoarrays, nanoflakes, nanocubes, dendrites, films, layers, or mesoporous structures. The single-metal-site compounds can comprise a metal-doped carbon-based material or a metal-N—C-based compound. Anodic catalyst species used for this purpose could include, but are not limited to, metals and/or ions of: Ir, Co, Cu, Ni, Fe, Pt, Rh, Re, Ru, Pd, Os, Mo, Ta, and mixtures and/or alloys thereof. For example, the anodic catalyst could be Ni such that the electrolyzer assembly included a nickel-based anode. The polymer electrolyte can be selected out of the same materials as the one used for the described membranes. The carbon-based compounds can comprise carbon nanofibers, carbon nanotubes, carbon black, graphite, boron-doped diamond powder, diamond nanopowder, boron nitride, or a combination thereof. The additives can be halide-based compounds including F, Br, I, and Cl. The additives can be specifically dedicated to modifying hydrophobicity such as treatment with PTFE or carbon black.

The anodic catalyst may be deposited onto a gas diffusion layer or a porous transport layer or any other support that facilitates the diffusion of gas from the interface of the anode to a purified gas stream separated from the cathodic stream. The anode area could also include a gas diffusion layer with one or more separators such as, but not limited to, membranes, polymeric materials, and diaphragms.

The nature of the liquid flowing through the porous separator may be an electrolyte. In specific embodiments of the invention, the cation of the electrolyte is an alkali metal, such as K⁺, Na⁺, Cs⁺, or Lit. Alternatively, it may be N-containing, such as NH4+, or a proton, H+. In specific embodiments of the invention, the anion of the electrolyte may be OH⁻, Cl⁻, Br⁻, F⁻, I⁻, CO₃2⁻, HCO₃⁻, NO₃⁻, NO₂⁻, S²⁻, SO₃²⁻, SO₄²⁻, HPO₃²⁻, PO₄³⁻, or any other anionic species. The concentration of the electrolyte may be 0.01 molar (M), 0.05 M, 0.1 M, 0.2 M, 0.5 M, 1 M, 2 M, 3 M, 4 M, 5 M, 6 M, 7 M, 8 M, 9 M and 10 M or higher.

In specific embodiments of the invention, the carbon monoxide electrolyzer includes one or more membranes chosen among anion-exchange membranes (such as, but not limited to, commercial Ionomr®, Orion®, Sustainion®, Piperion®, and ionomer anion-exchange membranes), cation-exchange membranes (such as but not limited to Nafion®, Aquivion® or commercial membranes), and bipolar membranes (such as, but not limited to, Fumasep® FBM and Xion®). In specific embodiments of the invention, the membrane in an anion-exchange membrane is prepared using N-bearing monomers. In one example, the electrolyzer includes an anion exchange membrane and hydroxide moves from the cathode to the anode. The oxidation product depends on the oxidation substrate, while the product harvested from the cathode output can be any of the generated chemicals mentioned above. In another example, the electrolyzer includes a cation exchange membrane and protons move from the anode to the cathode. The oxidation product again depends on the oxidation substrate, while the product harvested from the cathode output can be any of the generated chemicals mentioned above. The separator can also be a non-ion conducting polymeric separator, a diaphragm, a ceramic-containing material, a non-charged separator scaffold, a mixed ceramic-organic compound separator, or any other separator. Separation may occur via a bipolar membrane (including a mixture of cation- and anion-exchange membranes) or other types of separators, such as diaphragms, ceramic-containing materials (in particular mixed ceramic/organic compounds), or non-charged separator scaffolds.

The carbon monoxide electrolyzer can include a separating layer. In one example, the carbon monoxide electrolyzer comprises a central separating layer in which an electrolyte fluid is circulated, allowing the collection of liquid carbon-monoxide-reduction products that migrate from the cathode toward the central separating layer. In specific embodiments, the central separating layer is either separated from the cathode by an anion-exchange membrane or from the anode by a cation-exchange membrane, or both membranes are present. The central separator may be called a percolator. Useful products can be harvested both from the liquid stream from the separating layer and a gaseous stream from the cathode output. For example, the carbon monoxide could be used by the electrolyzer to produce one or more of the following: ethylene (C₂H₄), ethanol (C₂H₅OH), acetic acid (CH₃COOH), propylene (C₃H₆), or propanol (C₃H₈O). In a specific embodiment, the main targeted product is ethylene (in the gaseous product stream). In another specific embodiment, the main targeted products are ethylene (in the gaseous product stream) and ethanol (in the liquid product stream). In another specific embodiment, the main targeted products are ethylene (in the gaseous product stream) and acetic acid/acetate (in the liquid product stream).

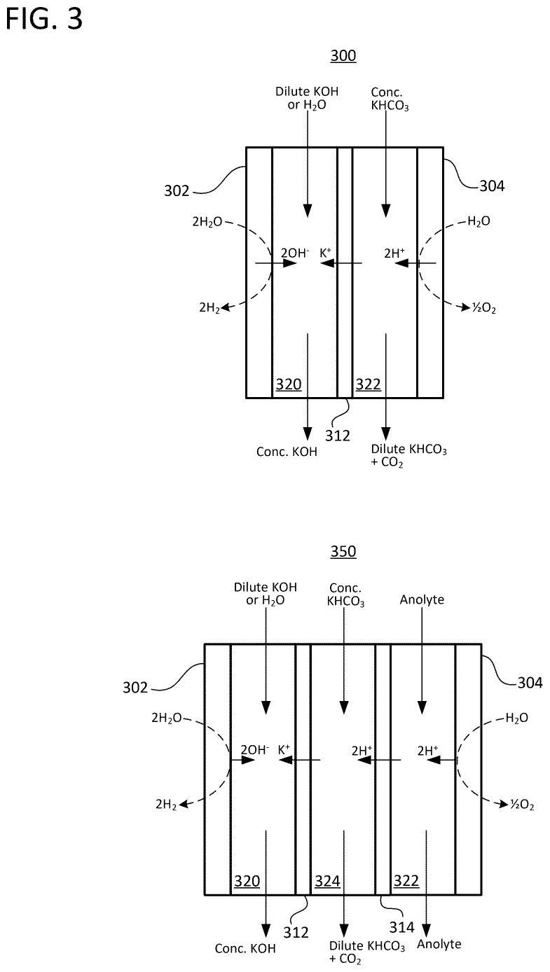

As previously mentioned with respect to FIGS. 1 and 2, the decarbonation electrolyzer 120 can be configured in many different ways to improve energy efficiency, direct ionic flow and mass transport, or to emphasize certain products. FIGS. 3-6 illustrate a number of these different configurations and variants thereof. Though these examples use potassium as an alkali metal cation, other options as outlined previously could be used instead.

FIG. 3 shows several variants of a standard decarbonation electrolyzer configured to electrochemically convert an aqueous alkali metal bicarbonate stream into a concentrated CO₂ stream and an alkali metal hydroxide stream in accordance with specific embodiments of the invention. In the embodiments shown, the decarbonation electrolyzer includes a cathode compartment in which a reduction reaction generates hydroxide ions, an anode compartment in which an oxidation reaction generates acidic equivalents, and at least one ion-selective separator disposed between the cathode and anode compartments.

In specific embodiments, a decarbonation electrolyzer 300 includes a cathode 302, an anode 304, and a membrane 312 disposed between the cathode and anode compartments. The membrane 312 may comprise a CEM configured to transport alkali metal cations from the anode side toward the cathode side while substantially limiting back-diffusion of hydroxide or crossover of gaseous products. An aqueous alkali metal bicarbonate stream is introduced as an anolyte into a reaction zone 322 adjacent to the anode, where protons generated by the anodic oxidation reaction protonate bicarbonate species to generate a concentrated CO₂ stream. The liberated CO₂ is withdrawn as a concentrated stream for later conversion, while alkali metal cations transported through the membrane migrate toward the cathode compartment 320 and combine with electrochemically generated hydroxide ions to form a concentrated alkali metal hydroxide stream. The catholyte can be dilute KOH, water, or a different catholyte with a desired conductivity. In specific embodiments, the membrane 312 may alternatively comprise an AEM with a different flow pattern. In either the case of a CEM or an AEM, the decarbonation electrolyzer 300 produces streams of hydrogen and oxygen that may be used elsewhere. In specific embodiments, membrane 312 can be a bipolar membrane. In this case, acid and base equivalents are generated in a catalytic layer in the bipolar membrane. This prevents the need to handle additional hydrogen or oxygen output streams while potentially reducing the energy needed for this step.

In specific embodiments, a decarbonation electrolyzer can have more than one membrane. Decarbonation electrolyzer 350 includes similar elements to electrolyzer 300, but also has a decarbonation chamber 324 where the concentrated potassium bicarbonate is added. The decarbonation chamber 324 receives the bicarbonate-containing feed stream and serves as a controlled reaction zone in which bicarbonate is protonated to release CO₂. In this example, a dual-CEM configuration was chosen including the membranes 312 and 314, but other combinations of AEMs and/or bipolar membranes could be used. The dual-membrane architecture can improve separation of product streams, reduce gas crossover, and provide greater control over pH gradients and ionic flux relative to a single-membrane configuration.

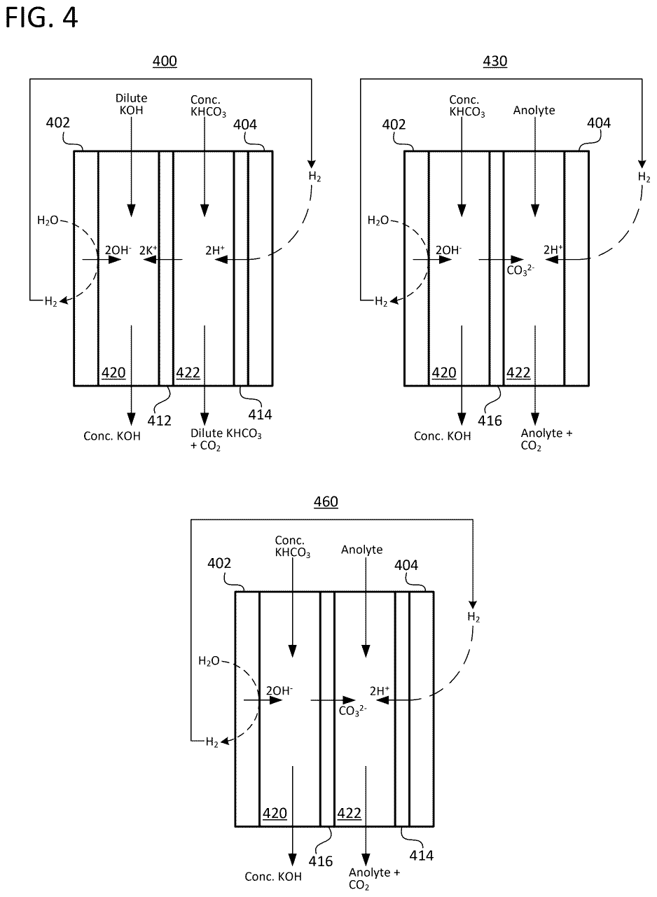

FIG. 4 shows several variants of a hydrogen-depolarized decarbonation electrolyzer configured to electrochemically convert an aqueous alkali metal bicarbonate stream into a concentrated CO₂ stream and an alkali metal hydroxide stream in accordance with specific embodiments of the invention. In the embodiments shown, hydrogen generated at the cathode is supplied to the opposing anode of the same cell to reduce the overall cell voltage. Hydrogen oxidation at the anode supplies protons for bicarbonate protonation, while the cathode produces hydroxide ions for alkali metal hydroxide regeneration. Internal reuse of electrochemically-generated hydrogen reduces the thermodynamic voltage requirement and improves overall energy efficiency.

In specific embodiments, a hydrogen-depolarized decarbonation electrolyzer 400 includes a cathode 402, a cathode chamber 420 configured to electrochemically generate hydrogen and hydroxide ions from water and combine hydroxide ions with potassium ions passed through CEM 412. An anode 404 is separated from an anode chamber 422 by another CEM 414. This section is configured to oxidize the hydrogen to generate protons. Protons generated at the anode contact a bicarbonate-containing stream to liberate CO₂, while alkali metal cations transported across the membrane combine with hydroxide ions in the cathode compartment to form a concentrated potassium hydroxide stream. The catholyte can be a dilute KOH solution or other electrolyte.

In specific embodiments, a variant of a hydrogen-depolarized decarbonation electrolyzer 430 includes a single AEM 416 positioned to promote transport of carbonate species toward a proton-generating region while retaining hydroxide ions in the cathode chamber 420. This configuration enables controlled management of carbonate transport rather than alkali metal transport. Hydrogen generated at the cathode is routed to the anode to depolarize the cell in a manner similar to decarbonation electrolyzer 400. One difference between decarbonation electrolyzer 430 and decarbonation electrolyzer 400 is that the potassium bicarbonate flows into the cathode chamber 420 instead of the anode chamber 422. The concentrated CO₂ stream still exits along with an anolyte, however.

In specific embodiments, a variant of a hydrogen-depolarized decarbonation electrolyzer 460 includes a combination of a CEM 414 and an AEM 416 defining multiple ionic transport pathways between the cathode and anode compartments. The dual-membrane configuration enables independent control of alkali metal cation transport and carbonate or proton transport, thereby improving selectivity, minimizing parasitic crossover, and enabling stable operation at elevated current densities. As in the other hydrogen-depolarized embodiments, hydrogen produced at one electrode is internally recycled to the opposing electrode to reduce cell voltage and improve electrical efficiency. Electrolyzer is similar to electrolyzer 430 except for the addition of a CEM 414 between the anode 404 and the anode chamber 422.

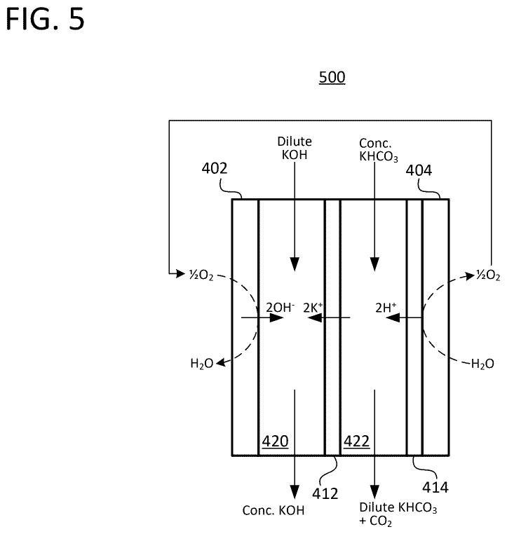

FIG. 5 shows a diagram of a representative embodiment of an oxygen-depolarized decarbonation electrolyzer in accordance with specific embodiments of the invention. This configuration is similar in structure to decarbonation electrolyzer 400 with a dual-CEM configuration, and the process flow of the anolyte and catholyte are similar as well. However, instead of a cathode product (hydrogen) being sent to the anode, an anode product oxygen is sent to the cathode. In the embodiment shown, oxygen, and hydrogen cations are generated at the anode. The oxygen is supplied to the opposing cathode to depolarize the cell. Oxygen reduction at the cathode consumes oxygen and generates hydroxide ions. The protons generated at the anode protonate bicarbonate species to liberate CO₂, and potassium cations migrate toward the cathode chamber 420 to combine with hydroxide ions to form a potassium hydroxide stream. In the embodiment as shown, two CEMs are used, but similar to variants in FIG. 4, similar variants using other ion exchange membranes are possible. Oxygen depolarization can reduce overall cell voltage and can be advantageous when oxygen is readily available or when oxygen management is integrated elsewhere in the system.

Note that in both types of depolarized decarbonation electrolyzer illustrated in FIGS. 4 and 5, the internal product is recycled to the other opposing half of the cell. In specific embodiments, oxygen or hydrogen from other cells or other electrochemical blocks in the system could be directed similarly to the cathode or anode respectively of a given decarbonation electrolyzer.

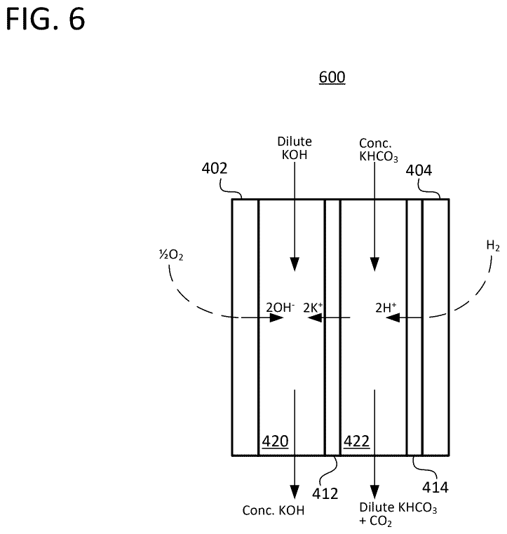

FIG. 6 shows a diagram of a representative embodiment of a fuel cell decarbonation electrolyzer 600 in accordance with specific embodiments of the invention. Decarbonation electrolyzer 600 has substantially the same structure as decarbonation electrolyzer 460, but operates in a power-generating mode rather than a power-consuming electrolysis mode. A fuel, such as hydrogen, is supplied to the anode, while an oxidant, such as oxygen, is supplied to the cathode. The electrochemical potential difference between the fuel oxidation reaction and the oxidant reduction reaction generates electrical power that can be recovered and supplied to other components of the system, including a CO₂ electrolyzer or auxiliary balance-of-plant equipment. Simultaneously, ionic transport within the decarbonation electrolyzer 600 generates acidic equivalents for bicarbonate protonation and basic equivalents for potassium hydroxide regeneration, thereby maintaining the same functional decarbonation and electrolyte recycling roles as in the electrolysis embodiments described above. The fuel cell configuration enables partial or complete offset of the electrical energy required for CO₂ capture and conversion while preserving closed-loop alkali metal operation.

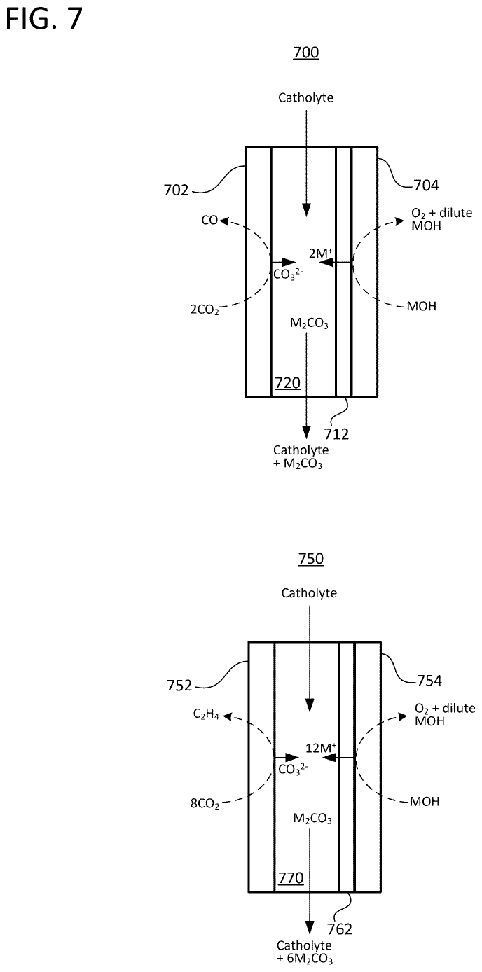

FIG. 7 shows several variants of a CO₂ electrolyzer configured to electrochemically convert a concentrated CO₂ stream and an alkali metal hydroxide stream into a reduced carbon product in accordance with specific embodiments of the invention. These can be used as the CO₂ electrolyzer 120 in FIG. 1. In the embodiments shown, the CO₂ electrolyzer includes a cathode configured to receive a CO₂-containing stream (either in gaseous form using, for example, a gas diffusing electrode or mixed in liquid form as part of a catholyte), and then electrochemically reduce at least a portion of the CO₂ to one or more reduced carbon products. The CO₂ electrolyzer also contains an anode configured to carry out an oxidation reaction, and at least one ion-selective separator disposed between the cathode and anode sections. Hydroxide ions generated at the cathode react with CO₂ in the presence of alkali metal cations transported toward the cathode to form alkali metal carbonate and/or bicarbonate in situ, thereby enabling simultaneous CO₂ conversion and electrolyte regeneration for recycle to an upstream CO₂ capture block.

In specific embodiments, a CO₂ electrolyzer 700 is configured to preferentially generate a reduced carbon product stream comprising CO. The electrolyzer 700 includes a cathode 702 having a gas diffusion layer and a CO-selective catalyst configured to reduce CO₂ to CO, and an anode 704 configured to oxidize water, hydroxide, hydrogen, or another suitable oxidation substrate. A cation-exchange membrane 712 is positioned between the cathode and anode compartments to transport alkali metal cations toward the cathode and to promote in situ formation of alkali metal carbonate from electrochemically generated hydroxide and CO₂. The gaseous cathode outlet includes a CO-containing product stream, while a liquid catholyte stream includes alkali metal carbonate and/or bicarbonate that is withdrawn from a catholyte chamber 720 for recycle to the CO2 capture block.

In specific embodiments, a CO₂ electrolyzer 750 is configured to preferentially generate one or more C2+ products, such as ethylene, ethanol, acetic acid, or combinations thereof, while maintaining substantially the same electrolyzer architecture as electrolyzer 700. The cathode 752 can have a different catalyst than electrolyzer 700 and is configured to promote multi-carbon product formation from CO₂ under alkaline or near-alkaline conditions. The anode 754 performs an oxidation reaction similar to that described above. A cation-exchange membrane 762 transports alkali metal cations toward the cathode to enable continued formation of alkali metal carbonate in situ from a portion of the supplied CO₂. In this configuration, a gaseous and/or liquid reduced carbon product stream is withdrawn from the cathode compartment 770, while the alkali metal carbonate-containing stream is recycled to the upstream CO₂ capture block to maintain closed-loop operation.

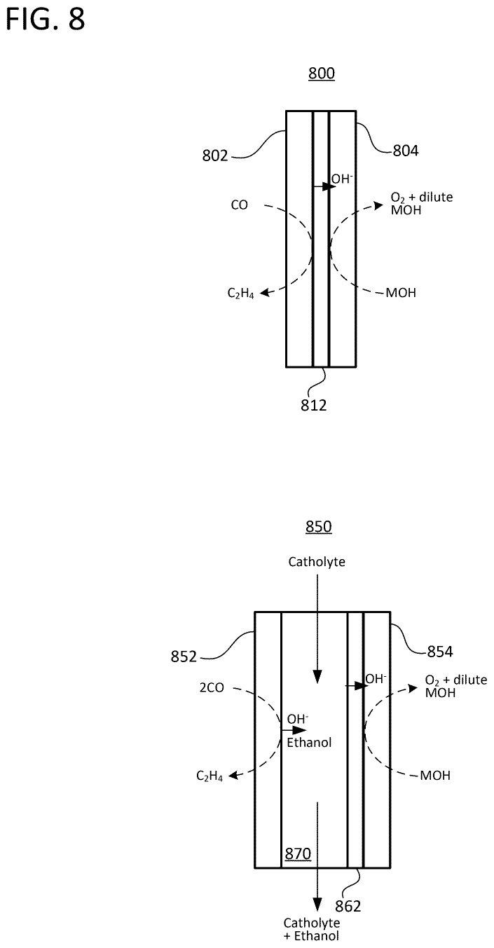

FIG. 8 shows a diagram of representative embodiments of a CO electrolyzer configured to electrochemically reduce CO to higher-value multi-carbon products in accordance with specific embodiments of the invention. In both embodiments shown, the CO electrolyzer includes a cathode compartment configured to receive a CO-containing gas stream and electrochemically reduce CO to one or more C2+ products, an anode compartment configured to carry out an oxidation reaction, and at least one ion-selective separator disposed between the cathode and anode compartments. Hydroxide ions generated during electrochemical reduction may migrate across the separator or be retained within a catholyte compartment depending on the selected membrane configuration and electrolyte management strategy.

In specific embodiments, a CO electrolyzer 800 includes a cathode 802 having a gas diffusion layer and a catalyst configured to reduce CO to ethylene, ethanol, acetic acid, or combinations thereof. In this example, the product is ethylene. The electrolyzer also has an anode 804 configured to oxidize water, hydroxide, hydrogen, or another suitable oxidation substrate to generate oxygen or other oxidation products. An AEM 812 may be positioned between the cathode and anode compartments to transport hydroxide ions from the cathode toward the anode, thereby maintaining alkaline operating conditions at the cathode and supporting high current density operation. A gaseous product stream comprising ethylene or other C2+ products is withdrawn from the cathode outlet, and a liquid catholyte stream may contain alcohols, carboxylates, or other liquid products for downstream separation or further processing.

In specific embodiments, a CO electrolyzer 850 includes a central separating chamber 870 positioned between the cathode 852 and anode 854 compartments to enable collection of liquid products independently of the gaseous product stream. The central separating chamber 870 may be separated from the cathode 852 by an AEM 862 or from the anode 854 by a CEM or bipolar membrane, thereby enabling controlled ionic transport and improved separation of liquid and gaseous products. In this configuration, liquid products such as ethanol, acetate, or other oxygenated compounds are recovered from the central separating layer, while gaseous products such as ethylene are recovered from the cathode outlet. The dual-separator architecture can improve product purity of each component.

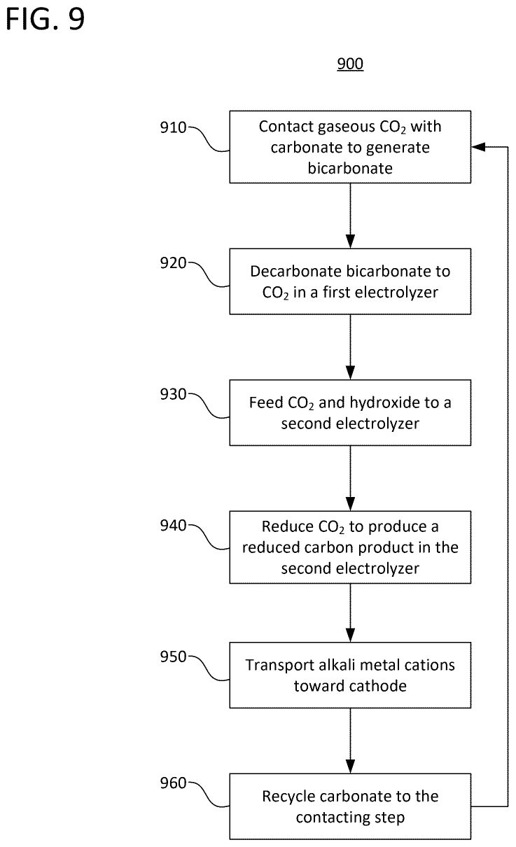

FIG. 9 shows a process 900 for operating a CO₂ capture and valorization system according to specific embodiments of the invention. Process 900 begins with step 910 where gaseous CO₂ is contacted with a carbonate to generate bicarbonate. This captures incoming gaseous CO₂ into solution. In step 920, the bicarbonate is decarbonated to regenerate CO₂ in a first electrolyzer. The resulting CO₂ is of higher purity and concentration than in the original gaseous CO₂. In step 930, the CO₂ regenerated in step 920 is fed to a second electrolyzer along with a portion of hydroxide.

In step 940, the CO₂ is reduced in a second electrolyzer to produce a reduced carbon product. Simultaneously to step 940, in step 950 alkali metal cations are transported to the second electrolyzer cathode. Finally, in step 960, carbonate thus formed is recycled back to the contacting step 910.

In specific embodiments utilizing CO₂ feedstocks with high concentrations (such as biogenic CO₂), the initial capture step may be replaced with a purification block including but not limited to separation technology at a high technology readiness level (TRL), such as pressure swing adsorption or a guard bed. In these cases, the M₂CO₃ formed by the cation-driven capture and electrolysis block can be used to purify the gaseous outlet of the electrolysis block to remove excess CO₂.

Careful selection of various types of blocks in systems 100 or 200 can greatly affect the power efficiency of such a system. Several examples will be examined and compared to traditional CO₂ electrolyzers.

### Power Efficiency Example 1

As an example in the case where CO₂ is converted to CO, the decarbonation block may be depolarized with oxygen (for example, using decarbonation electrolyzer 500) with a voltage of 0.8 volts (V) per cell or lower, requiring 192,970 coulombs per mol (C/mol) (2 electrons transferred, multiplied by Faraday's constant) of MOH and CO₂ generated. The cation-driven carbon capture and electrolysis reactor could require 1.8 V per cell and requires 192,970 C/mol of CO generated (2 electrons transferred, multiplied by Faraday's constant). On the other hand, a typical CO₂ electrolyzer in neutral or acidic conditions requires 3.0 V per cell and requires 192,970 C/mol of CO generated. These values can be used to calculate the watt-hours (Wh) required to generate 1 mol of CO from CO₂ in both systems, as shown in Table 1.

TABLE 1
Comparison of the energy consumed through a cation-driven
carbon capture and electrolysis unit + electrolyte decarbonation
vs. a typical CO₂-to-CO electrolysis system

| | | E cell | Energy of block | Total energy |
|---|---|---|---|---|
| System | Block | V | Wh/mol | Wh/mol |
| Proposed | Cation-driven carbon capture | 1.8 | 96 | 138 |
| system | and electrolysis of CO₂ | | | |
| | Electrolyte decarbonation | 0.8 | 43 | |
| Standard CO₂ | CO₂ electrolysis with no | 3.0 | 161 | 161 |
| electrolyzer | accumulation of electrolyte | | | |
| | carbonates | | | |

### Power Efficiency Example 2

Significant energy savings can also be made in the conversion of CO₂ to ethylene, which requires 1,157,820 C/mol of ethylene produced in the cation-driven carbon capture and electrolysis block. This reaction captures 6 mol of CO₂ as alkali metal carbonate, which in turn require 1,157,820 C to be regenerated from the alkali metal carbonate. A neutral or acidic CO₂ electrolyzer typically requires 3.5 V to undertake the same reaction. See Table 2 for expected energy consumption of the different systems.

TABLE 2
Comparison of the energy consumed through a cation-driven
carbon capture and electrolysis unit + electrolyte decarbonation vs. a
typical CO₂-to-C₂H₄ electrolysis system

| | | E cell | Energy of block | Total energy |
|---|---|---|---|---|
| System | Block | V | Wh/mol | Wh/mol |
| Proposed | Cation-driven carbon capture | 2.2 | 707 | 965 |
| system | and electrolysis of CO₂-to- | | | |
| | C₂H₄ | | | |
| | Electrolyte decarbonation | 0.8 | 257 | |
| | of MHCO₃ | | | |
| Standard | CO2 electrolysis with no | 3.5 | 1125.6 | 1125.6 |
| CO₂ | accumulation of electrolyte | | | |
| electrolyzer | carbonates | | | |

Notably, the comparison in Table 2 assumes 100% electronic selectivity (Faradaic efficiency, FE) for CO₂-to-C₂H₄. With more realistic efficiency values, the energy advantage of the proposed system becomes even more significant. For example, at 60% FE in both systems, the proposed system requires 1436 Wh/mol C₂H₄ compared to 1876 Wh/mol C₂H₄ for the standard CO₂ electrolyzer.

### Power Efficiency Example 3

Further energy savings can be made by coupling CO₂-to-CO conversion with a separate CO-to-ethylene electrolyzer (requiring 771,880 C/mol C₂H₄), which does not produce carbonated electrolytes and functions with low voltages (^{~}2 V). See Table 3 for typical voltages and energy requirements; it should be noted that the CO₂ electrolyzer will require twice the power for the CO₂-to-CO electrolysis and decarbonation steps due to the two equivalents of CO required to form ethylene.

TABLE 3
Comparison of the energy consumed through a cation-driven carbon capture
and electrolysis unit undertaking CO₂-to-CO + a CO-to-C₂H₄ electrolyzer +
electrolyte decarbonation vs. a typical CO₂-to C₂H₄ electrolysis system

| | | E cell | Energy of block | Total energy |
|---|---|---|---|---|
| System | Block | V | Wh/mol | Wh/mol |
| Proposed | Cation-driven carbon | 1.8 | 193 | 708 |
| system | capture and electrolysis | | | |
| | of CO₂-to-CO | | | |
| | Electrolyte decarbonation | 0.8 | 86 | |
| | of MHCO₃ | | | |
| | CO-to-C₂H₄ electrolyzer | 2.0 | 429 | |
| Standard CO₂ | CO₂ electrolysis with no | 3.5 | 1125.6 | 1125.6 |
| electrolyzer | accumulation of | | | |
| | electrolyte carbonates | | | |

Notably, the comparison in Table 3 assumes 100% FE for CO₂-to-C₂H₄. With more realistic efficiency values, the energy advantage of the proposed system becomes even more significant. For example, at 60% FE in both systems, the proposed system requires 1180 Wh/mol C₂H₄ compared to 1876 Wh/mol C₂H₄ for the standard CO₂ electrolyzer.

Additionally, standard CO₂ electrolyzers require upstream purification units when using dilute CO₂ sources (e.g. biogenic or flue gas), such as pressure swing adsorption (PSA) or amine capture, adding to the energy consumption shown in Tables 1 and 2. The proposed system integrates CO₂ separation and purification from the initial gas mixture, creating additional energy savings not reflected in these tables.

Following are detailed examples of CO₂ capture and valorization systems as depicted in FIGS. 1 and 2. These examples are not intended to be limiting but merely to illustrate how various subsystems can be designed.

### System Example 1

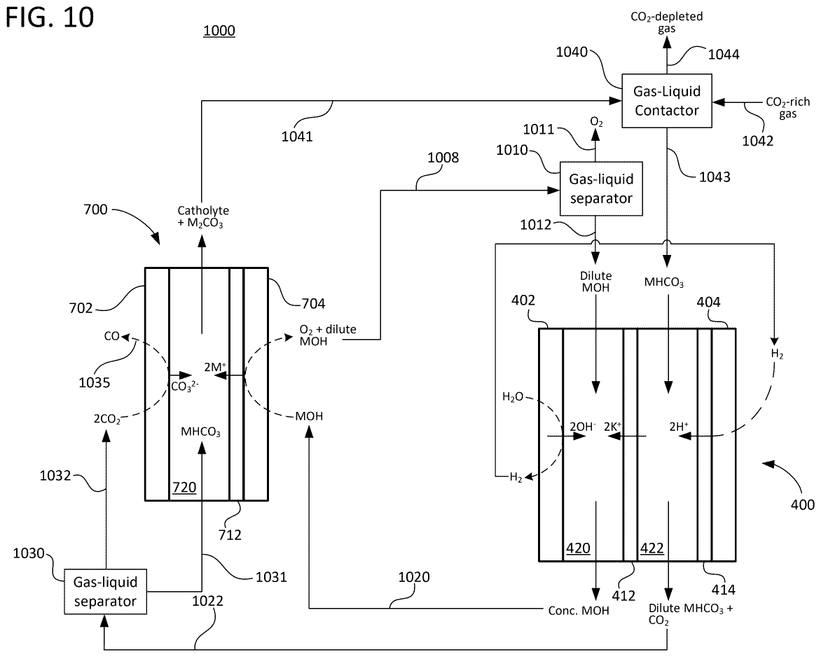

FIG. 10 shows a diagram of a detailed CO₂ capture and valorization system 1000 in accordance with specific embodiments of the invention. The system 1000 represents an integrated implementation of the system architecture previously described with respect to system 100 and includes a CO₂ capture block 110 implemented as a gas-liquid contactor 1040, where an input CO₂-rich gas 1042 contacts an alkali metal carbonate stream 1041, and outputs a bicarbonate stream 1043 to a decarbonation block (e.g., decarbonation electrolyzer 400) along with a CO₂-depleted gas stream 1044. In the embodiment as shown, the decarbonation electrolyzer 120 is represented by a hydrogen-depolarized decarbonation electrolyzer 400 as previously described with respect to FIG. 4, and the CO₂ electrolyzer 130 is represented by a CO₂ electrolyzer 700 as previously described with respect to FIG. 7. The decarbonation electrolyzer 400 receives a bicarbonate-containing aqueous stream 1043 and generates a concentrated CO₂ stream 1022 and an alkali metal hydroxide stream 1020, which are supplied to the CO₂ electrolyzer 700. Concentrated MOH stream 1020 can be fed to the anode 704 side directly. The concentrated CO₂ stream 1022 is first sent to a gas-liquid separator 1030. Gaseous CO₂ stream 1032 is sent to the cathode and the remaining dilute alkali metal bicarbonate stream 1031 is used as a catholyte in the cathode chamber 720. CO stream 1035 is the output gas product and may be routed to downstream utilization, purification, or storage. The output of the anode is a stream 1008 comprising oxygen and dilute MOH. Oxygen is separated as a gas product stream 1011 by a gas-liquid separator 1010. In this configuration, the remaining dilute MOH stream 1012 can be used as the catholyte in cathode chamber 420. Aqueous alkali metal carbonate stream 1041 is recycled to the gas-liquid contactor 1040 to complete the cycle.

In specific embodiments, the cathode of the decarbonation electrolyzer 400 comprises a gas-diffusion layer and a Ni-based catalyst, and the anode comprises Pt, for example as a foam, mesh, or a deposit onto a conductive porous layer. In specific embodiments, the cathode of the CO₂ electrolyzer 700 comprises an Ag/Au-based catalyst, and the anode comprises a Ni or NiFe material.

### System Example 2

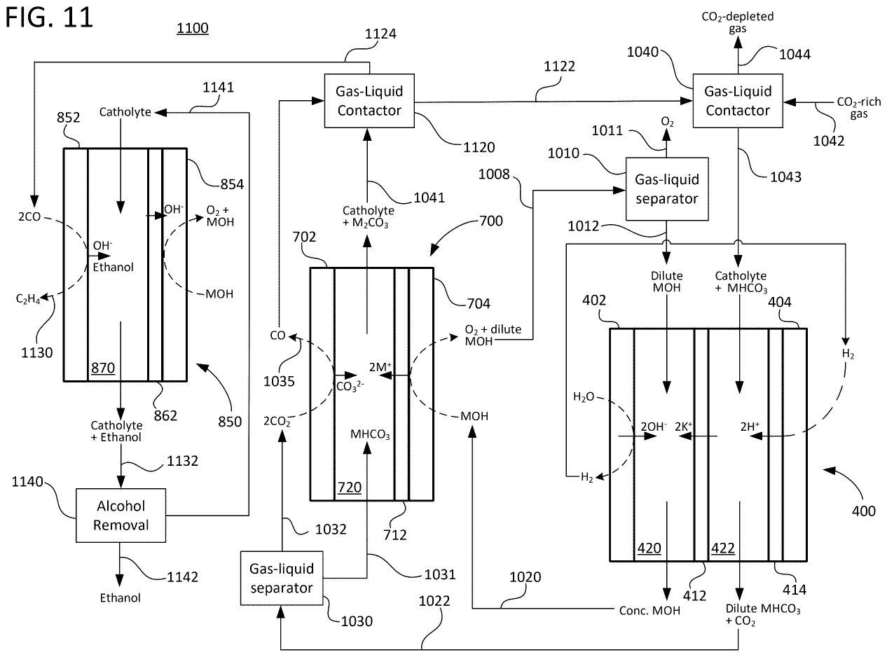

FIG. 11 shows a diagram of a detailed carbon capture and valorization system 1100 in accordance with specific embodiments of the invention. The system 1100 represents an integrated implementation of the system architecture previously described with respect to system 200. System 1100 has many elements in common with system 1000 of FIG. 10, including a gas-liquid contactor 1040, decarbonation electrolyzer 400 and CO₂ electrolyzer 700. In system 1100, CO-containing output stream 1035 is further valorized in a third electrolyzer. First, stream 1035 is passed to a separate gas-liquid contactor 1120, which is similar in nature to the primary gas-liquid contactor 1040 used to capture CO₂ initially. Alkali metal carbonate stream 1041 is passed through the gas-liquid contactor 1120 to remove any unreacted CO₂ from the CO stream 1035. This continues in stream 1122 to cycle back to the gas-liquid contactor 1040 to close the cycle similarly to system 1000. The purified CO stream 1124 is sent to a CO electrolyzer block. In this example, CO electrolyzer 850 is used to convert CO stream to products including a gaseous ethylene stream 1130 and a liquid ethanol stream 1132. Ethanol can be removed from the liquid ethanol stream 1132 which includes ethanol and a catholyte, in an alcohol removal separator 1140. Purified ethanol stream 1142 is an additional product. The catholyte 1141 can be recycled to the catholyte chamber 870.

### System Example 3

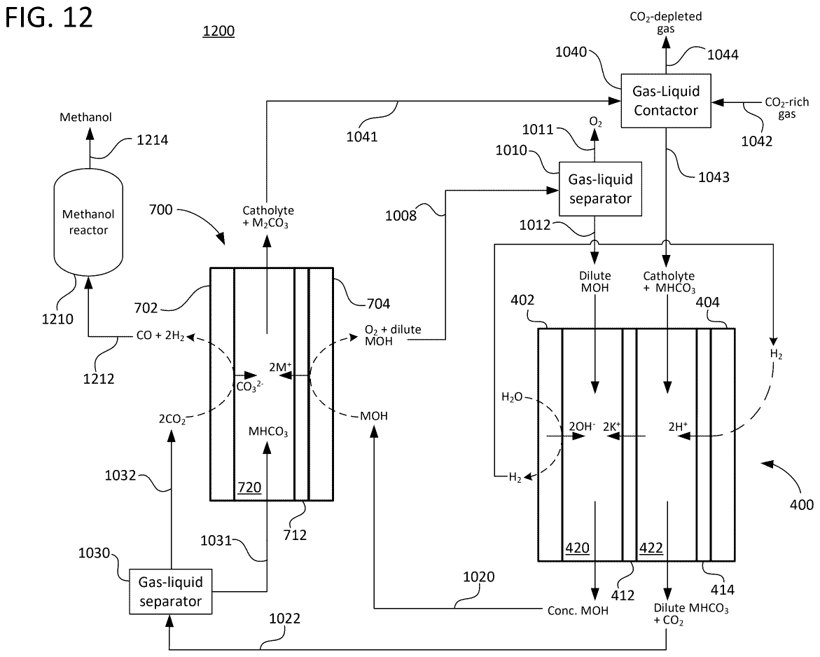

FIG. 12 shows a diagram of a detailed carbon capture and valorization system 1200 in accordance with specific embodiments of the invention. System 1200 represents an implementation of system architecture similar to system 100 but shows an external chemical reactor for later valorization of its reduced carbon-containing product. The main carbon capture and electrolyzer loop is nearly the same as shown for system 1000. One difference is that CO₂ electrolyzer 700 can be configured to produce sufficient additional hydrogen gas to create a syngas stream 1212. Although some amount of hydrogen is commonly produced along with CO, selection of reactor conditions including temperature, catalyst materials and design, and the like can be chosen so that a desired ratio of hydrogen:CO is produced at the syngas output stream 1212. In this example, the syngas is fed to a methanol reactor 1210 to produce a methanol stream 1214. Methanol reactors can often accept either a CO or a CO₂ stream as a carbon-containing input, so in this example there does not need to be additional purification of the CO output stream to remove residual CO₂. The generated carbon monoxide and hydrogen are fed to a reactor at, for example, pressures between 5 and 20 bar and temperatures of around 300° C. that is filled with a catalyst able to convert them into methanol. The excess heat of the reaction may be used elsewhere in the reaction scheme, for example to purify output gases using temperature swing adsorption. It may also be used by any neighboring heat-requiring processes.

### System Example 4

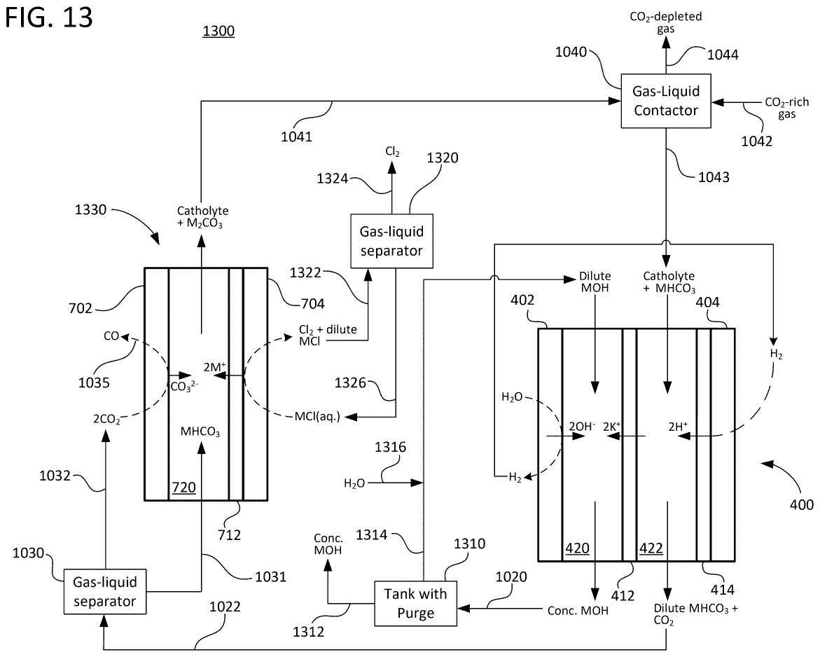

FIG. 13 shows a diagram of a detailed carbon capture and valorization system 1300 in accordance with specific embodiments of the invention. System 1300 represents an implementation of system architecture similar to system 100 but shows a different electrochemical reaction at the CO₂ electrolyzer anode. The main carbon capture and electrolyzer loop is nearly the same as shown for system 1000 up to the output of the decarbonation electrolyzer 400. In system 1000, the CO₂ electrolyzer 700 includes both CO, alkali metal carbonate, and oxygen output streams. In this example, the CO₂ electrolyzer 1330 has been configured to oxidize a metal chloride to chlorine rather than oxidizing a metal hydroxide to oxygen, in accordance with Eq. 15 as described previously with respect to a CO₂ electrolyzer.

In specific embodiments, concentrated CO₂ stream 1022 is still separated and supplied as a gaseous CO₂ stream 1032 to the CO₂ electrolyzer 1330. The concentrated MOH stream 1020 is passed to a tank with a purge 1310. Further concentrated MOH stream 1312 can be stored, sold, or valorized separately. The remainder electrolyte stream 1314 can be diluted with water 1316 and recycled as a dilute MOH catholyte in the decarbonation electrolyzer 400.

In specific embodiments, the CO₂ electrolyzer receives a metal chloride stream 1326 and converts this at the anode to chlorine gas. A chlorine and dilute metal chloride stream 1322 can be passed to a gas-liquid separator 1320 that produces a chlorine gas stream 1324. Remaining metal chloride is recycled to stream 1326, where additional MCI brine solution can be introduced as a make-up. In specific embodiments, the cathode of the CO₂ electrolyzer comprises a gas-diffusion layer and an Ag/Au-based catalyst. In specific embodiments, the anode material can be Ir or an IrTa material of any shape, including, but not limited to, a foam, a mesh, or a deposit onto a conductive porous transport layer.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the scope of the present invention, which is more particularly set forth in the appended claims.

What is claimed is:

1. A system for capturing and electrochemically converting carbon dioxide, comprising:
a carbon dioxide capture block configured to contact a gaseous stream comprising carbon dioxide with an aqueous alkali metal carbonate to convert carbon dioxide into an aqueous alkali metal bicarbonate;
a decarbonation electrolyzer that receives the aqueous alkali metal bicarbonate from the carbon dioxide capture block and electrochemically generates (i) a concentrated carbon dioxide stream; and (ii) an alkali metal hydroxide stream;
a carbon dioxide reduction electrolyzer that receives the concentrated carbon dioxide stream and the alkali metal hydroxide stream from the decarbonation electrolyzer, electrochemically reduces a portion of the concentrated carbon dioxide stream to at least one reduced carbon product stream, and generates an alkali metal carbonate stream from a second portion of the concentrated carbon dioxide stream; and
a recycling conduit fluidly connecting the carbon dioxide reduction electrolyzer and the carbon dioxide capture block, whereby the alkali metal carbonate stream generated in the carbon dioxide reduction electrolyzer is transported to the carbon dioxide capture block.

2. The system of claim 1, wherein the carbon dioxide capture block converts at least 50% of the carbon dioxide in the gaseous stream to bicarbonate.

3. The system of claim 1, wherein the carbon dioxide reduction electrolyzer has a cation-driven ion transport configuration that transports alkali metal cations toward a cathode.

4. The system of claim 3, wherein the cation-driven ion transport configuration comprises a cation exchange membrane.

5. The system of claim 3, wherein the cation-driven ion transport configuration promotes in situ formation of alkali metal carbonate during electrochemical reduction of carbon dioxide.

6. The system of claim 1, wherein the concentrated carbon dioxide stream supplied to the carbon dioxide reduction electrolyzer is in a gas phase.

7. The system of claim 1, wherein the alkali metal hydroxide stream is supplied to the carbon dioxide reduction electrolyzer as an aqueous solution.

8. The system of claim 1, wherein the aqueous alkali metal carbonate is generated by reaction of electrochemically produced hydroxide with carbon dioxide at a cathode of the carbon dioxide reduction electrolyzer.

9. The system of claim 1, wherein the at least one reduced carbon product stream comprises carbon monoxide.

10. The system of claim 9, further comprising a carbon monoxide electrolyzer that receives carbon monoxide from the at least one reduced carbon product stream and electrochemically converts a portion of the carbon monoxide in the at least one reduced carbon product stream to at least one C2+ product selected from ethylene, ethanol, acetic acid, or combinations thereof.

11. The system of claim 1, wherein the at least one reduced carbon product stream comprises at least one C2+ product selected from ethylene, ethanol, acetic acid, or combinations thereof.

12. The system of claim 1, wherein the carbon dioxide reduction electrolyzer additionally generates a hydrogen stream.

13. The system of claim 1, wherein the decarbonation electrolyzer further comprises a bipolar membrane.

14. The system of claim 1, wherein the decarbonation electrolyzer is operated in a depolarized mode.

15. The system of claim 1, wherein the decarbonation electrolyzer also operates as a fuel cell to generate power.

16. A method for integrated capture and electrochemical conversion of carbon dioxide, comprising:
contacting a gaseous stream comprising carbon dioxide with an aqueous alkali metal carbonate to capture at least a portion of the carbon dioxide as an aqueous alkali metal bicarbonate;
decarbonating the aqueous alkali metal bicarbonate in a first electrolyzer to generate a concentrated carbon dioxide stream and an alkali metal hydroxide stream;
feeding the concentrated carbon dioxide stream and the alkali metal hydroxide stream to a second electrolyzer;
electrochemically reducing carbon dioxide in the second electrolyzer to produce at least one reduced carbon product;
transporting alkali metal cations within the second electrolyzer toward a cathode to promote in situ formation of alkali metal carbonate; and
recycling the alkali metal carbonate formed during electrochemical reduction to the contacting step;
wherein the at least one reduced carbon product and the alkali metal carbonate are each generated using a portion of the concentrated carbon dioxide stream.

17. The method of claim 16, wherein the contacting step captures carbon dioxide from a gaseous stream selected from flue gas, biogenic gas, air, or mixtures thereof.

18. The method of claim 16, wherein the first electrolyzer generates a carbon dioxide stream having a higher carbon dioxide concentration than the gaseous stream contacted in the contacting step.

19. The method of claim 16, wherein the method operates with no net consumption of alkali metal species.

20. A system for capturing and electrochemically converting carbon dioxide, comprising:
a carbon dioxide capture block configured to absorb carbon dioxide from a gaseous stream into an aqueous stream to form an aqueous alkali metal bicarbonate;
a depolarized decarbonation electrolyzer that receives the aqueous alkali metal bicarbonate and electrochemically generates: (i) a concentrated carbon dioxide stream; (ii) an alkali metal hydroxide stream; and (iii) at least one electrochemically generated product that is generated at a first electrode and is then supplied to an opposing electrode to reduce a cell voltage of the depolarized decarbonation electrolyzer;
a carbon dioxide reduction electrolyzer that receives the concentrated carbon dioxide stream and the alkali metal hydroxide stream from the depolarized decarbonation electrolyzer, electrochemically reduces carbon dioxide to at least one reduced carbon product, and generates an alkali metal carbonate or bicarbonate; and
a recycling conduit fluidly connecting the carbon dioxide reduction electrolyzer and the carbon dioxide capture block.

21. The system of claim 20, wherein the depolarized decarbonation electrolyzer is hydrogen-depolarized, wherein the at least one electrochemically generated product comprises hydrogen; and hydrogen generated at a cathode of the depolarized decarbonation electrolyzer is supplied to an anode of the depolarized decarbonation electrolyzer.

22. The system of claim 20, wherein the depolarized decarbonation electrolyzer is oxygen-depolarized, wherein the at least one electrochemically generated product comprises oxygen; and oxygen generated at an anode of the depolarized decarbonation electrolyzer is supplied to a cathode of the depolarized decarbonation electrolyzer.

23. The system of claim 20, wherein the carbon dioxide reduction electrolyzer is configured with a cation-driven ion transport configuration that transports alkali metal cations toward a cathode and promotes formation of alkali metal carbonate during electrochemical reduction of carbon dioxide.

24. The system of claim 20, wherein the aqueous stream in the carbon dioxide capture block comprises an alkali metal carbonate.

25. The system of claim 20, wherein the aqueous stream in the carbon dioxide capture block comprises an alkali metal hydroxide.

26. The system of claim 20, wherein the aqueous stream in the carbon dioxide capture block comprises an alkali metal bicarbonate.
